(19) United States
(12) Patent Application Publication
(10) Pub. No.: US 2003/0004047 A1
(43) Pub. Date: Jan. 2, 2003

(54) Process for collecting bags, device for carrying out the process and chain of bags, as well as chain of stacks of bags

(76) Inventors: Ulrich Stienecker, Ladbergen (DE); Hans-Ludwig Voss, Tecklenburg (DE); Konrad Tetenborg, Lengerich (DE); Uwe Koehn, Osnabrueck (DE)

Correspondence Address: JACOBSON HOLMAN PLLC, 400 SEVENTH STREET N.W., SUITE 600, WASHINGTON, DC, 20004, US

(21) Appl. No.: 10/153,823

(22) Filed: May 24, 2002

(30) Foreign Application Priority Data
Jun. 28, 2001 (DE) 101 34 508.9

(51) Int. Cl. B31B 1/64

(52) U.S. Cl. 493/204; 493/163

(57) ABSTRACT

The invention relates to a process for collecting bags, in particular packaging bags made of plastic. According to the invention, the bags are tacked offset in succession on a supporting web via a lip, formed on their open side, thus forming a chain of bags. Furthermore, the invention relates to a device for carrying out the process, a chain of bags, as well as a chain of stacks of bags.

The invention relates to a process for collecting bags, in particular packaging bags made of plastic, a device for carrying out the process and a chain of bags, as well as a chain of stacks of bags.

The bags to be processed here are usually made of plastic, for example polyethylene. They are made of plastic film and produced by folding and welding by a well-known method. They are delivered individually in succession to the end of the device, which produces the bags. In the packaging machines, where the bags are filled with arbitrary objects, the bags are usually not fed individually in succession, but rather said bags, collected in the form of a stack, are put into a corresponding bag storage of the packaging machine, from where they are removed from the respective stack and moved along automatically for filling.

The collection of bags is disclosed, for example, in the DE 39 17 809 A1. Here the bags are stacked in corresponding stacks by slipping them on two pins, which are disposed on a transport and lie side by side.

The handling of the stacks of bags formed in this manner has a drawback.

The object of the present invention is to propose a new process for collecting bags, with which process a large number of bags can be collected in a simple manner into one large unit, which makes it possible to remove the bags in a simple manner from the filling and packaging machine.

The invention solves this problem, first of all, with a process, according to claim 1. Correspondingly, in the process for collecting bags, the bags are tacked offset in succession on a supporting web via a lip, formed on their open side, thus forming a chain of bags. The chain of bags formed thus makes it possible to collect a large number of bags semi-continuously in a large storage unit, from which said bag chain can be removed again in a simple manner. In this respect it is especially advantageous that owing to a connection by way of tacking on the supporting web, only one very narrow lip has to be formed on the open side of the bag, since here the lip does not have to exhibit any corresponding receiving openings for pushing through the corresponding holding pins. Thus, the width of the lip and thus the waste can be reduced from usually approximately 35 mm to 5 mm. Thus, a large portion of the plastic material that must be otherwise used can be saved.

Special advantages of the process are disclosed in the dependent claims following the said claim. Correspondingly the tacking is done by cementing or welding between the lip of the bag and the supporting web. For the adhesive connection, all known adhesives resulting from plastics processing are suitable. One can conceive of welding in the same way, since with the bag material that is used, for example polyethylene, it is fast and easy to tack with a weld-tack-seam.

It is especially advantageous to wind the chain of bags into a roll on a winding mandrel. Upon reaching the desired layer diameter, the winding mandrel can be removed from the winding station and conveyed into a corresponding filling and packaging machine, where it can be deposited in its own winding station.

A parallel solution of the problem posed in the introductory part of the specification is disclosed in the inventive process, according to claim 4. According to this solution of the invention, the bags are collected in stacks of bags comprising several bags, forming a chain of stacks of bags. Here, too, the stacks of bags are connected together by way of lips, formed on their open side, and tacked offset on a supporting web by means of attachment means. Here, in contrast to the first solution of the invention, the stacks of bags are formed, to be sure, as disclosed in principle in the prior art, according to DE 39 17 809 A1. However, these stacks of bags are connected in turn to a supporting web, thus forming a large unit of a chain of stacks of bags, which feature significantly facilitates the handling of the bags, in particular in the filling and packaging machine.

Especially advantageous embodiments of this process are disclosed in the dependent claims, following the main claim. Correspondingly, the attachment means can comprise at least one pin, which is pushed through the lips of the individual bags and the supporting web and is closed. Here, too, it is especially advantageous if the chain of stacks of bags, formed by offset stacking of the individual stacks of bags on the supporting web, is wound into a roll.

A device for carrying out the first process of the invention comprises a transfer unit, which feeds the bags individually to a tacking station, where they can be tacked on a supporting web, which runs vertically to the bag's direction of motion.

The transfer units can comprise a bottom suction belt and an upper suction belt, to each of which suction channels are allocated. In this manner the individually delivered bags can be easily grasped and transported to the transfer unit.

The transfer unit exhibits a stamp between two upper suction channels, which are allocated to the suction belts, and a tacking stamp can be arranged in the region of the tacking operation to be carried out. To tack the bags on the supporting web, the bag can be forced, after suitable interruption of the vacuum in the suction channels, on the supporting web by means of the stamp and the tacking stamp and can be connected to said supporting web by means of the tacking stamp. Owing to this process, very high processing speeds are realized that enable a semi continuous collection of the bags to form a storage unit.

To form the roll, the device has advantageously a winding mandrel, on which the chain of bags can be wound.

A device for carrying out the second inventive process for solving the aforementioned problem includes a perforation device for perforating the supporting web and a transfer station, where the stack of bags, collected with at least one pin, can be pinned on the supporting web by means of the pin. Furthermore, there is a pin locking station, where the pins, pushed through the supporting web, are closed by means of a pin locking mechanism.

A motor driven winding mandrel can be disposed advantageously on a swivel arm, on which the chain of stacks of bags can be wound into a roll.

A holding strap feed can be arranged in such a manner in the device that the chain of stacks of bags can be wound together with the holding strap on the winding mandrel, forming a stable winding.

In addition, a flattener can be provided that serves to smooth out the chain of stacks of bags prior to winding on the winding mandrel. Thus, a more compact and tighter roll can be produced.

Furthermore, the invention relates to a chain of bags, produced according to the process of any one of the claims 1 to 3. According to the invention, this chain of bags exhibits bags, offset in succession on a supporting web, whereby said bags are tacked on the supporting web by way of a lip, formed on their open side. The narrow lip of each bag can exhibit advantageously a perforation, along which the bag can be severed from the supporting web.

Finally the inventive solution also comprises a chain of stacks of bags, which were produced in a process, according to any one of the claims 3 to 5. Said chain comprises a supporting web, on which the several bags, which are collected to form stacks of bags, are connected together by way of lips formed on their open side, and tacked on by means of attachment means.

Other details and advantages of the invention follow from the embodiments, depicted in the drawings.

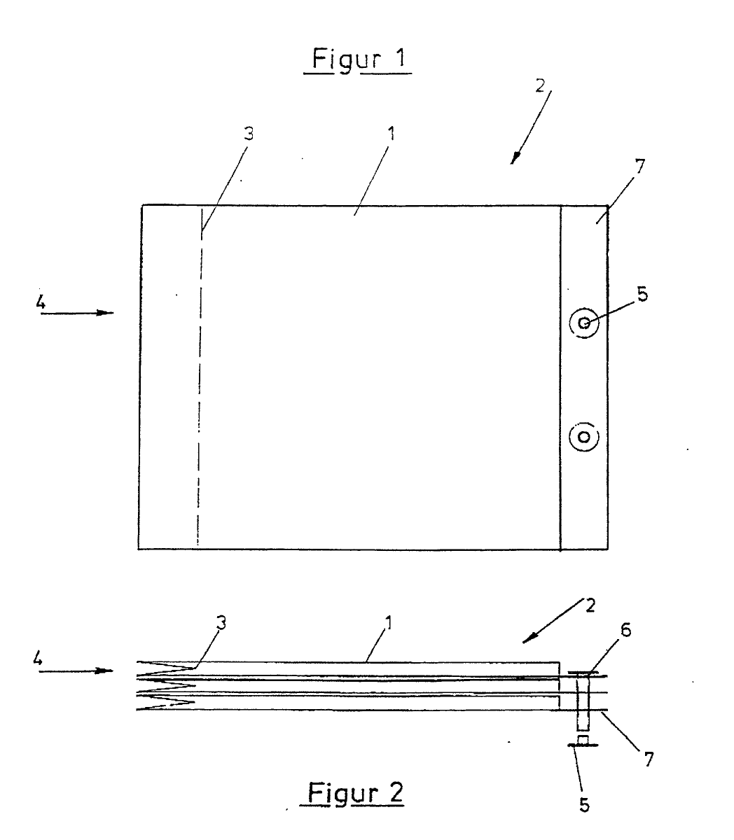

FIG. 1 is a top view of a stack of bags, according to the prior art.

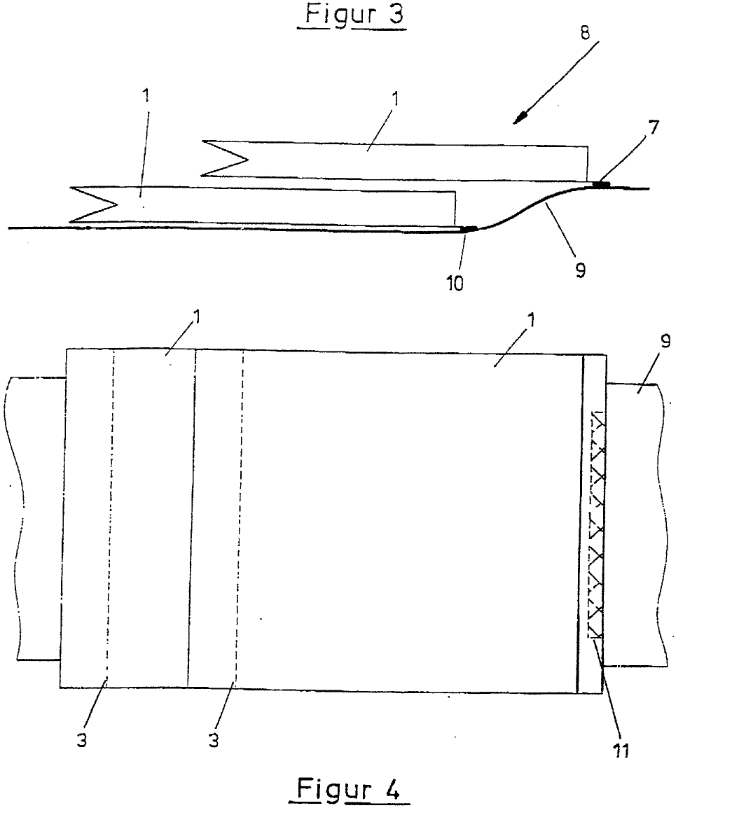

FIG. 2 is a side view of a stack of bags, according to FIG. 1.

FIG. 3 is a side view of a chain of bags.

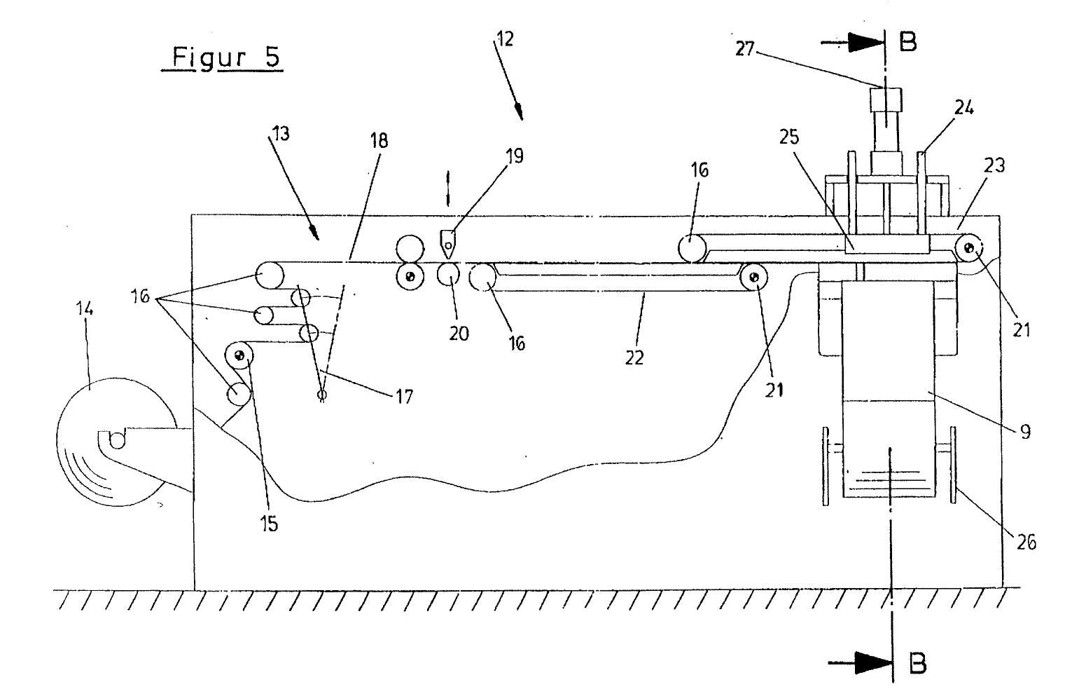

FIG. 4 is a top view of a chain of bags.

FIG. 5 is a device for producing a chain of bags.

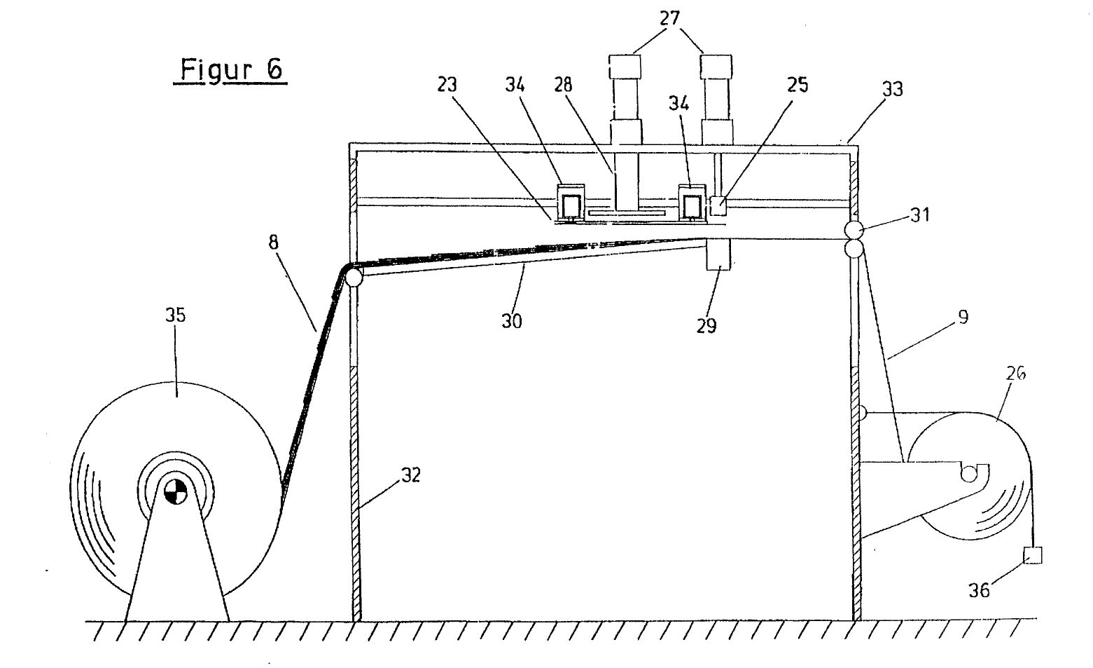

FIG. 6 depicts a section B-B, according to FIG. 5.

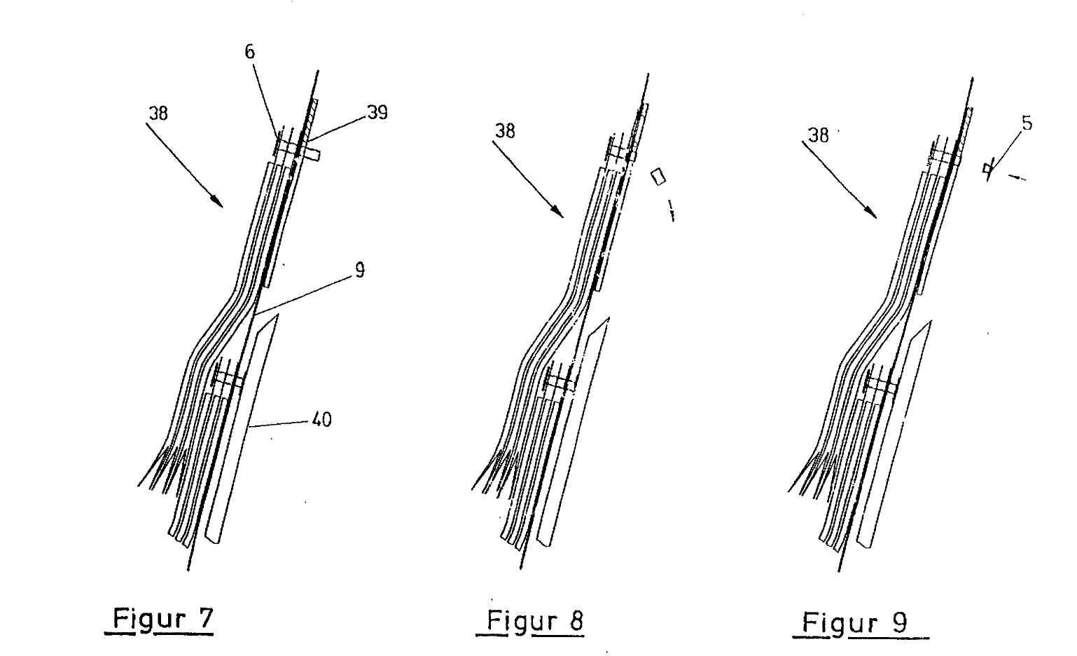

FIG. 7 depicts a detail from a chain of stacks of bags, according to FIG. 10.

FIG. 8 depicts another detail from a chain of stacks of bags, according to FIG. 10.

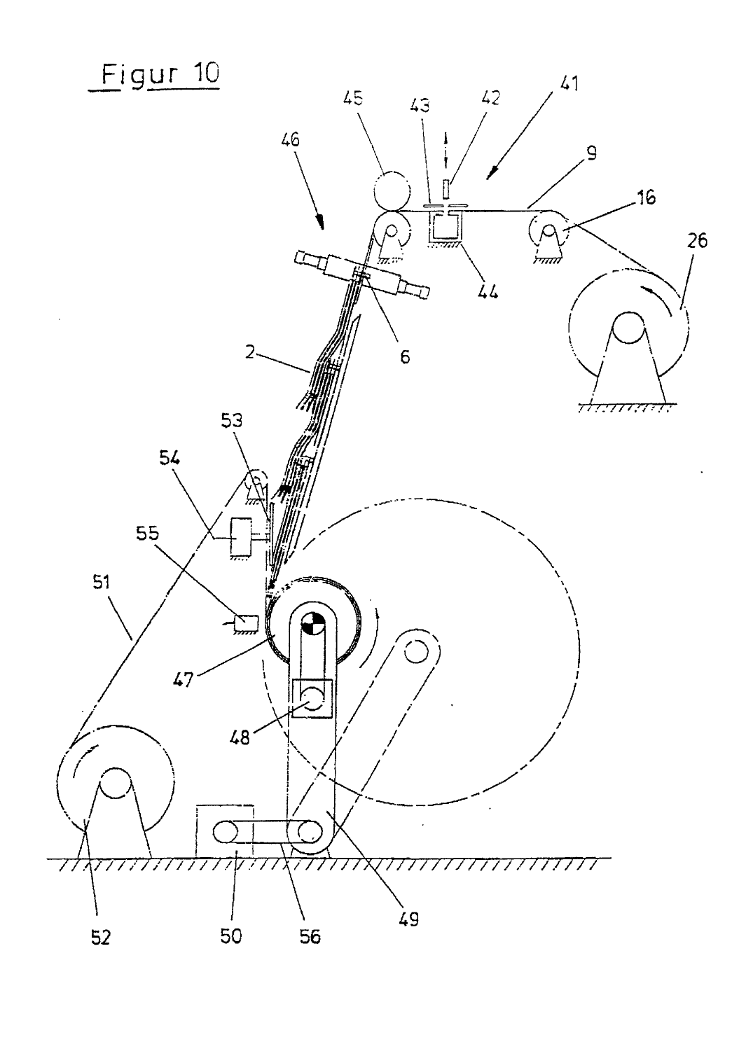

FIG. 9 depicts a third detail from a chain of stacks of bags, according to FIG. 10.

FIG. 10 depicts a device for producing a chain of stacks of bags, according to the present invention.

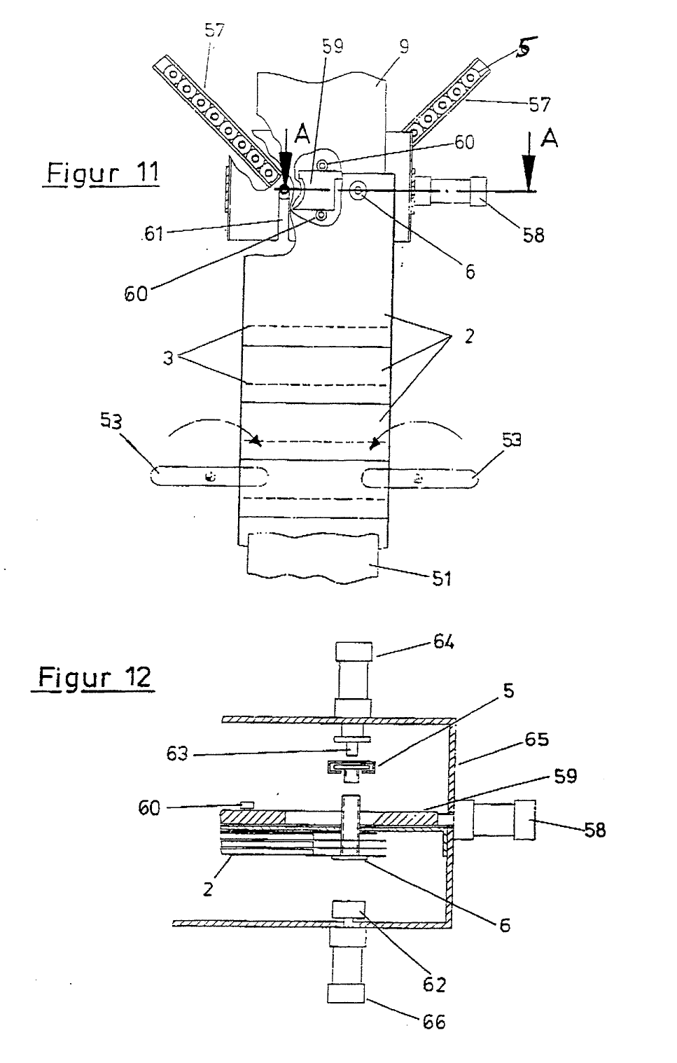

FIG. 11 is a side view of the device, depicted in FIG. 10, where only the features between the points A and B of FIG. 10 are depicted; and

FIG. 12 depicts a section B-B, according to FIG. 11.

FIGS. 1 and 2 show how in the prior art bags are collected to form a stack of bags. The bags 1 are made, for example, of polyethylene. The bag, shown in FIG. 1, exhibits a bottom fold 4. The fold edge 3 is indicated by a dashed line. A lip 7, which is formed as an extension of the lower side wall, is formed on the front open side of the bag 1. The details of this feature are especially evident from the stack of bags, according to FIG. 2. The lips 7 of the bags 1 are joined together via a pin 6, whereby the pin 6 is closed in such a manner by means of a pin fastening mechanism 5 that the bags 1 cannot slide off the pin.

FIGS. 3 and 4 depict a part of the inventive chain of bags 8. It comprises a supporting web 9 and on it tacked bags 1, which are stacked offset in succession and which also exhibit in this embodiment a bottom fold, forming a fold edge 3. The bags 1, depicted here, have only one short lip 7, which is formed as an extension of the lower side wall in the front end of the bag. The bags 1 are connected to the supporting web, by way of a corresponding tack point 10, which can be formed by cementing or welding.

FIG. 4 shows in the region of the lip 7 a tear-off perforation, which facilitates the removal of the bag from the supporting web 9. In the top view of FIG. 4, the region of the lip 7 that is tacked on the supporting web 9 is indicated by the cross-hatched region. In the embodiment, shown here, the supporting web 9 is narrower than the width of the bags 1.

FIG. 5 depicts a part of the device 12 for producing the chain of bags. It comprises in the left part a device for forming bags that is already known from the prior art. Here, the film 18, required to form the bag, is unrolled, for example, from a supply roll 14 by way of a continuous front draw 15, and guided over the deflection rollers 16, whereby a part of the deflection rollers is guided by means of a storage oscillating follower 17, which serves to facilitate a continuous drawing off from the supply roll despite the cyclical formation of the bags. The film material 18 is fed to a transverse welding tool 19, opposite which is a counter welding roller 20, in order to form a transverse weld. The bag is welded and separated here by a method that is adequately known.

The individually formed bags are grasped by parallel lower suction belts 22, which are guided over a driven roller 21 and a deflection roller 16. The individually transported bags are carried away with positional accuracy by means of the driven suction belts, in which a vacuum can be produced by means of corresponding suction channels, allocated thereto. Said bags are grasped on the end of the lower suction belts 22 by upper suction belts 23, which are also guided around a driven roller 21 and a deflection roller 16. By means of these upper suction belts 23, the bags are transported into a transfer unit, which comprises in essence a stamp 28 and a tacking stamp for welding and/or cementing 25. The design of this part is especially evident from the sectional view B-B through FIG. 5, depicted in FIG. 6. Here, it follows that the stamp 28 is arranged between two upper suction channels 34, which are allocated to the parallel upper suction belts 23, whereas the tacking stamp 25 lies on the side next to one of the upper suction channels 34. Opposite the tacking stamp 25 is a counter support 29. Between the tacking stamp and the counter support the supporting web 9 runs vertically to the orientation of the suction belts 22 or 23. The stamp 28 and/or the tacking stamp 25 is/are moved by means of the socalled pneumatic operated tipper in the direction of the supporting web, which runs under said tipper and which is braced by way of a table 30. The table 30 is mounted in a frame 32. To transfer the bags and to tack on the supporting web 9, the vacuum is interrupted in the upper suction channels; and the stamp 28 and the tacking stamp 25 are moved by means of the pneumatic operated tipper 27 in the direction of the supporting web 9, so that the bag is deposited on the supporting web and connected to the supporting web 9 in the area of the lip 7 between the tacking stamp 25 and the counter support 29. The bags are deposited in such a manner on the supporting web that the result is the characteristic chain of bags. It is wound into a roll 35 on a mandrel. The supporting web 9 is unwound from a supply roll 26. To tension the supporting web 9, the supply roll 26 exhibits a brake 36 for the supporting web.

FIGS. 7, 8 and 9 depict chains of stacks of bags, according to the present invention. Here stacks of several bags 1, stacked one on top of the other, are deposited on the supporting web 9. The bags are collected by way of a pin 6 and pushed with the pin 6 into a perforation 39 in the supporting web 9 . It is immediately clear from FIGS. 7 to 9, how the stack of bags is connected securely to the supporting web. First, FIG. 7 shows how the pin 6, which is pushed through the corresponding lips of the stack of bags, is also pushed through the perforation 39 in the supporting web and projects beyond the supporting web. Then, in FIG. 8 the projecting length of the pin 6 is cut off at the surface of the supporting web, a feature that is shown in a schematic drawing of the part of the pin 6 that is shown separately. Then FIG. 9 shows how a pin locking mechanism 5 is moved in the direction of the pin 6. The pin locking mechanism 5 serves to be connected to the pin 6, whereby the connection can be achieved by means of a force fit, cementing or welding.

FIG. 10 depicts the entire device for forming a chain of stacks of bags 38, as depicted in FIGS. 7 to 9. The supporting web is unrolled from a supply roll 26 for the supporting web 9 and guided over deflection rollers 16. In a perforation device 41, the web is guided along under a guide plate 43, through which a perforation bolt 42 can be moved in the direction of the double arrows, in order to provide the supporting web 9 with the perforations 39. A waste container is marked 44. The length for the fixed cycle operation is measured via the roller 45 by a method that is well-known. The number 46 indicates a transfer station for the preformed stacks of bags, which are fastened via the pins 6 on the supporting web 9. Here it is not illustrated in detail how the pins 6 are locked. It will be explained in detail below with reference to FIGS. 11 and 12. The stacks of bags can be transported in any arbitrary manner and put on the supporting web 9 by means of transfer grippers, which are not shown here in detail. The stacks of bags, deposited offset on the supporting web 9, are transported further and wound on a winding mandrel 47, driven via a winding motor. The winding mandrel 47 is pivot-mounted together with the motor 48 in the swivel arm 49, whereby the swivel arm can be swivelled via a motor 50 and a drive belt 56. The swivelling is a function of the growth of the winding, which is wound on the winding mandrel 47 and belongs to the chain of stacks of bags 38. To form a denser winding, a holding strap 51 is unwound from a supply roll 52 and wound together with a chain of stacks of bags 38 on the winding to form a correspondingly compact roll. A thickness gauge 55 serves to determine the thickness of the winding and to drive correspondingly the motor 50 to swing the swivel arms 49.

The stacks of bags 2 on the chain of stacks of bags are also smoothed out prior to winding by means of a flattener 53, which can be driven by a motor via a drive 54.

FIGS. 11 and 12 depict a device, where the pins 6 are cut off and provided with a pin locking mechanism 5. FIG. 11 depicts the chain of stacks of bags 38, which comprises the individual stacks of bags 2. In the bottom area of FIG. 11 the holding strap 51 is partially cut; and above it the rotating flatteners 53, which flatten the stacks of bags 2 on the side, are shown.

In the area of the supporting web 9, beyond which the pins 6 project, as shown in FIG. 7, there is a knife 59, which is driven via a pneumatic cylinder 58 and which is guided between two knife guides 60 and which cuts off the projecting length of the pin 6 by means of a corresponding translatory movement (see also FIG. 12). The pin locking mechanisms 5 are fed via supply magazines 57. As especially evident from FIG. 12, said pin locking mechanisms bring about a press connection between the pin locking mechanism 5 and the pin 6 by means of a pneumatic cylinder for the pin locking mechanism 64 or a pneumatic cylinder 66 with counter pressure stamp 62 for the pins 6. In FIG. 11 a passage slot for the pins is indicated with the number 61.

1. Process for collecting bags (1), in particular packaging bags made of plastic, characterized in
that the bags (1) are tacked offset in succession on a supporting web (9) via a lip (7), formed on their open side, thus forming a chain of bags (8):

2. Process, as claimed in claim 1, characterized in that the tacking is done by cementing or welding between the lip (7) of the bag (1) and the supporting web (9).

3. Process, as claimed in claim 1 or 2, characterized in that the chain of bags (8), formed by the offset stacking of individual bags (1) on the supporting web (9), is wound into a roll.

4. Process for collecting bags (1), in particular packaging bags made of plastic, characterized in
that said bags are collected in stacks of bags (2) with several bags (1), forming a chain of stacks of bags (38), and connected together via lips (7), formed on their open side, and are tacked offset on a supporting web (9) by means of fastening means (6).

5. Process, as claimed in claim 4, characterized in that the attachment means comprise a pin (6), which is pushed through the lips (7) of the individual bags (1) and the supporting web (9) and is closed.

6. Process, as claimed in claim 4 or 5, characterized in that the chain of stacks of bags (38), formed by offset stacking of the individual stacks of bags (2) on the supporting web (9), is wound into a roll.

7. Device for carrying out a process for collecting bags, as claimed in any one of the claims 1 to 3, characterized in that it comprises transfer units (22, 23), which feed the bags individually to a tacking station, in which they can be tacked on a supporting web (9), which runs vertically to the bag's direction of motion.

8. Device, as claimed in claim 7, characterized in that the transfer units comprise a bottom suction belt (22) and an upper suction belt (23), to which suction channels (34) are allocated.

9. Device, as claimed in claim 8, characterized in that the transfer station exhibits a stamp (28) between two upper suction channels (34), and that a tacking stamp (25) is arranged in the region of the tacking to be carried out.

10. Device, as claimed in any one of the claims 7 to 9, characterized in that there is a winding mandrel (37), on which the chain of bags can be wound.

11. Device for carrying out a process for collecting bags, as claimed in any one of the claims 4 to 6, characterized in that it includes a perforation device (41) for perforating the supporting web (9) and a transfer station (46), in which the stack of bags (2), joined together with at least one pin (6), can be pinned on the supporting web (9) by means of the pin (6); and a pin locking station, in which the pins (6), pushed through the supporting web (9), are closed by means of a pin locking mechanism (5).

12. Device, as claimed in claim 11, characterized in that a motor driven winding mandrel (47) is disposed on a swivel arm (49), on which the chain of stacks of bags (38) can be wound into a roll.

13. Device, as claimed in claim 11 or 12, characterized in that a holding strap feed (52) is arranged in such a manner in the device that the chain of stacks of bags (38) can be wound together with the holding strap (51) on the winding mandrel (47), forming a stable winding.

14. Device, as claimed in any one of the claims 11 to 13, characterized in that there is also a flattener (53) that serves to smooth out the chain of stacks of bags (38) prior to winding on the winding mandrel (47).

15. Chain of bags, produced according to the process, as claimed in any one of the claims 1 to 3, characterized in that there are bags (1), offset in succession on a supporting web (9), whereby said bags are tacked on the supporting web (9) by way of a lip (7), formed on their open side.

16. Chain of bags, as claimed in claim 14, characterized in that the narrow lip (7) of each bag (1) exhibits a perforation (11), along which the bag (1) can be severed from the supporting web (9).

17. Chain of stacks of bags, produced in a process, as claimed in any one of the claims 3 to 5, characterized in that on a supporting web (9), several bags (1), which are collected to form stacks of bags (2), are connected together by way of lips formed on their open side, and tacked on by means of attachment means (6).
